(19) United States
(12) Patent Application Publication
(10) Pub. No.: US 2003/0063544 A1
(43) Pub. Date: Apr. 3, 2003

(54) Optical disk recording apparatus with adaptive power control of laser beam

(75) Inventor: Keishi Matsumoto, Hamamatsu (JP)

Correspondence Address: Roger R. Wise, Pillsbury Winthrop LLP, Suite 1200, 725 South Figueroa Street, Los Angeles, CA, 90017-5443, US

(73) Assignee: Yamaha Corporation, Hamamatsu-shi (JP)

(21) Appl. No.: 10/255,907

(22) Filed: Sep. 26, 2002

(30) Foreign Application Priority Data
Sep. 28, 2001 (JP) 2001-304583

(51) Int. Cl. G11B 7/00

(52) U.S. Cl. 369/59.14; 369/53.37

(57) ABSTRACT

An optical disk recording apparatus is designed for recording information on an optical disk by irradiation of a laser beam according to a given control procedure under a given recording condition. In the optical disk recording apparatus, an acquiring section acts when an operation of recording information is performed for acquiring the recording condition associated to the operation to be performed. A selecting section selects a control procedure according to the acquired recording condition from a plurality of different control procedures which are prepared beforehand. A control section controls the irradiation of the laser beam according to the selected control procedure during the operation of recording information. The selecting section selects the control procedure effective to enable the control section to regulate an irradiation power of the laser beam with a regulation accuracy matching a quality level of recording information indicated by the acquired recording condition.

### BACKGROUND OF THE INVENTION

1. Technical Field of the Invention

The present invention relates to an optical disk recording apparatus and optical disk recording method in which an optical disk is irradiated with a laser beam to perform recording of information.

2. Related Art

As a recording method of recordable optical disks such as a compact disc recordable (CD-R) and compact disc rewritable (CD-RW), a high-velocity recording has heretofore been performed to record information at a multiple linear velocity (e.g., double velocity, 4-times velocity, . . . , and the like) which is higher than a standard linear velocity. When such high-velocity recording is performed, a time required for the recording can be shortened.

The recording has heretofore been performed while suppressing errors as much as possible in the respective multiple recording velocities, by changing a recording laser power intensity in accordance with a recording velocity magnification described above, or by changing so-called strategies to adjust an irradiation time, irradiation start timing, and the like of the laser beam.

Among the techniques of handling the variation of the recording velocity magnification, as a technique of controlling the recording laser power to be optimum in accordance with the velocity variation, there has been proposed a method comprising: performing a test recording with a plurality of recording laser power values in a predetermined region of the optical disk prior to a real recording; and executing an optimum power control (OPC: optimum recording power adjustment of a recording laser beam) to obtain the recording laser power value from the signal reproduction result of the test recording region such that an optimum recording is performed.

At present, because of changing in the recording linear velocity during the recording under a constant angular velocity (CAV) method, and because of a high recording velocity and for other reasons, it is considered as most important to more accurately perform the recording with an optimum laser power for reduction of the recording error. Therefore, there have been proposed various methods such as a method of executing OPC several times prior to the real recording and obtaining the optimum recording power, and a method of executing a laser power control called a running OPC (ROPC) to control the laser power in response to a return light reflected back from the optical disk during the real recording.

By the way, in the laser power control method of executing the OPC several times, the optimum laser power is obtained so that the recording can more accurately be performed as compared with the method of executing OPC once, but much time is required for the recording. Therefore, when the recording is performed at a high velocity, it is certainly preferable to perform the OPC several times. However, when the recording is performed at a relatively low velocity (e.g., when information is recorded in an inner peripheral portion of the disk during the CAV recording), precision is not required so much for the OPC. In the method of executing the OPC several times as described above, time is consumed more than necessary if the recording velocity is relatively low.

### SUMMARY OF THE INVENTION

The present invention has been developed in consideration of the above-described circumstance, and an object thereof is to provide an optical disk recording apparatus and optical disk recording method in which the recording is performed with a good balance between recording quality level and necessary time even with variation of a situation and condition concerning the recording and a preferable recording can thus be performed in accordance with the variable situation or condition.

To solve the problem, according to the present invention, there is provided an optical disk recording apparatus for recording information on an optical disk by irradiation of a laser beam according to a given control procedure under a given recording condition. In the inventive optical disk recording apparatus, an acquiring section acts when an operation of recording information is performed for acquiring the recording condition associated to the operation to be performed. A selecting section selects a control procedure according to the acquired recording condition from a plurality of different control procedures which are prepared beforehand. A control section controls the irradiation of the laser beam according to the selected control procedure during the operation of recording information.

Moreover, according to the present invention, there is provided an optical disk recording method for recording information on an optical disk by irradiation of a laser beam according to a given control procedure under a given recording condition. The inventive method is carried out by the steps of acquiring the recording condition when an operation of recording information is performed, the recording condition being associated to the operation to be performed, selecting a control procedure according to the acquired recording condition from a plurality of different control procedures which are prepared beforehand, and controlling the irradiation of the laser beam according to the selected control procedure during the operation of recording information.

According to these apparatus and method, when the information is to be recorded in the optical disk, the preferable irradiation control procedure is selected beforehand from a plurality of executable irradiation light control procedures in accordance with the situation or condition concerning the recording, and data can be recorded according to the selected irradiation control procedure. Therefore, even when the situation concerning the recording varies in diverse aspects such as a recording mode, recording start position, recording velocity, disk characteristics, and disk environment, the preferable recording can be performed in matching with the diverse situations.

### BRIEF DESCRIPTION OF THE DRAWINGS

FIG. 1 is a block diagram showing a constitution of an optical disk recording apparatus according to one embodiment of the present invention.

FIG. 2 is an table diagram showing contents of a database for selection stored in a ROM of the optical disk recording apparatus.

FIG. 3 is a sequence flowchart showing an operation of a host PC and optical disk recording apparatus during recording of information on an optical disk.

FIG. 4 is a diagram showing one example of a displayed screen by an application executed by the host PC during the recording with respect to the optical disk.

FIG. 5 is a flowchart showing a procedure of laser power control during the recording which can be executed by the optical disk recording apparatus.

FIG. 6 is an explanatory view of a region constitution of the optical disk subjected to the recording by the optical disk recording apparatus.

FIG. 7 is an explanatory diagram of a power control method in which ROPC is executed by the optical disk recording apparatus.

FIG. 8 is a flowchart showing another procedure of the laser power control during the recording which can be executed by the optical disk recording apparatus.

FIG. 9 is a graph showing a relation between a laser power and a recording linear velocity for use in the procedure executed by the optical disk recording apparatus.

FIG. 10 is a flowchart showing still another procedure of the laser power control during the recording which can be executed by the optical disk recording apparatus.

FIG. 11 is an explanatory table diagram showing contents of the database for selection stored in the ROM in a modification example of the optical disk recording apparatus.

FIG. 12 is an explanatory table diagram showing contents of the database for selection stored in the ROM in another modification example of the optical disk recording apparatus.

FIG. 13 is an explanatory table diagram showing contents of the database for selection stored in the ROM in another modification example of the optical disk recording apparatus.

FIG. 14 is an explanatory table diagram showing contents of the database for selection stored in the ROM in still another modification example of the optical disk recording apparatus.

FIG. 15 is an explanatory table diagram showing contents of the database for selection stored in the ROM in still another modification example of the optical disk recording apparatus.

### DETAILED DESCRIPTION OF THE INVENTION

Embodiments of the present invention will be described hereinafter with reference to the drawings.

A. Constitution of Embodiment

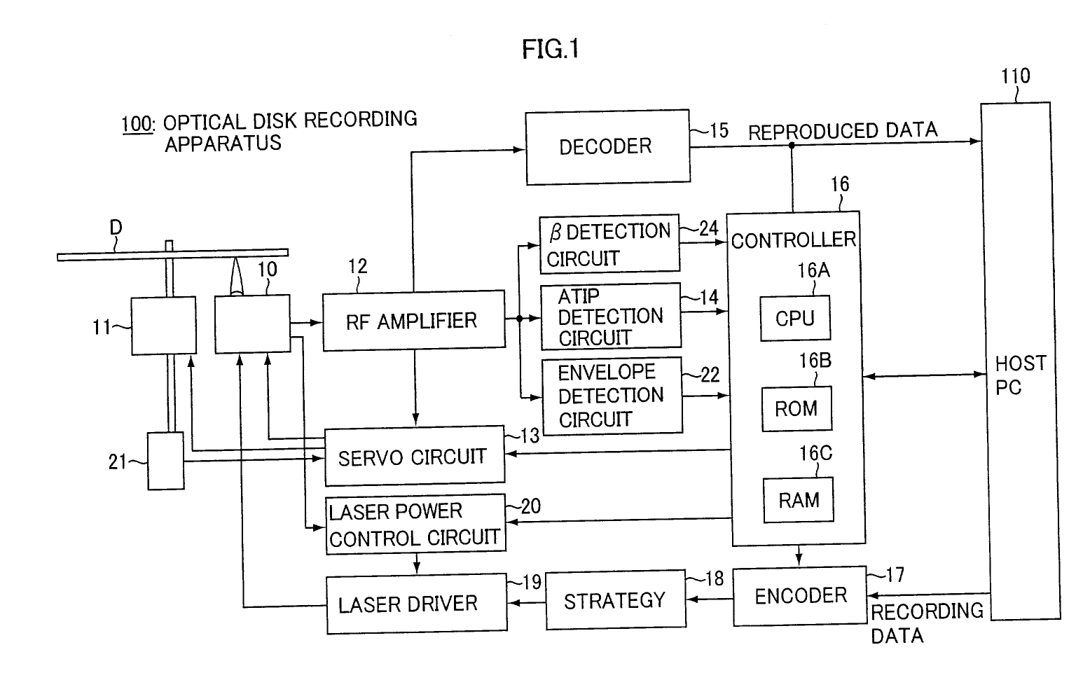

First, FIG. 1 is a block diagram showing a constitution of an optical disk recording apparatus according to one embodiment of the present invention. As shown in the drawing, an optical disk recording apparatus 100 is connected to a host personal computer (PC) 110, and includes an optical pickup 10, spindle motor 11, radio frequency (RF) amplifier 12, servo circuit 13, ATIP detection circuit 14, decoder 15, controller 16, encoder 17, strategy circuit 18, laser driver 19, laser power control circuit 20, frequency generator 21, envelope detection circuit 22, and β detection circuit 24.

The spindle motor 11 is a motor which rotates and drives an optical disk D as an object in which data is to be recorded. The optical pickup 10 has an optical system such as a laser diode, lens and mirror, and a return light receiving element, irradiates the optical disk D with the laser beam during recording and reproducing, receives a return light reflected back from the optical disk D, and outputs an RF signal subjected to eight-to-fourteen modulation (EFM) in the RF amplifier 12. Moreover, the optical pickup 10 has a monitor diode. During the recording, an electric current is generated in the monitor diode by the return light from the optical disk D, and the current is supplied to the laser power control circuit 20 from the optical pickup 10.

The RF amplifier 12 amplifies the EFM-modulated RF signal supplied from the optical pickup 10, and outputs the amplified RF signal to those of the servo circuit 13, ATIP detection circuit 14, envelope detection circuit 22, β detection circuit 24 and decoder 15. The decoder 15 subjects the EFM-modulated RF signal supplied from the RF amplifier 12 to EFM demodulation and generates reproduction data during the reproducing.

The ATIP detection circuit 14 extracts a wobble signal component from the EFM signal supplied from the RF amplifier 12, decodes ATIP information included in the wobble signal component, acquires absolute time information indicating a position on the optical disk D, identification information for identifying the disk, information indicating the type of the disk such as a dyestuff of the disk, and the like, and outputs the information to the controller 16.

The β detection circuit 24 calculates a β value (asymmetry) as a parameter concerning a reproducing signal quality level from the EFM-modulated RF signal supplied from the RF amplifier 12 during the reproducing of a test recording region, and outputs a calculation result to the controller 16. Assuming that a peak level (sign is +) of an EFM-modulated signal waveform is a, and bottom level (sign is −) is b, the β value is obtained by (a+b)/(a−b).

The envelope detection circuit 22 detects an envelope of the EFM signal reproduced from a count region of the above-described optical disk D in order to detect a portion of a predetermined test region of the optical disk D from which a test recording is to start before performing the above-described test recording.

The servo circuit 13 executes a rotation control of the spindle motor 11, and a focus control, tracking control, and feed control of the optical pickup 10. As a driving method of the spindle motor 11 during the recording, either a constant angular velocity (CAV) method for driving the optical disk D at a constant angular velocity or a constant linear velocity (CLV) method for rotating/driving the optical disk D so as to obtain a constant recording linear velocity may be used, and the optical disk recording apparatus 100 in the present embodiment can select either of the CAV and CLV methods in response to a user's instruction, and the like. In the optical disk recording apparatus 100 according to the present embodiment, the CAV method is employed, and the servo circuit 13 rotates/drives the spindle motor 11 at the constant angular velocity.

The encoder 17 subjects supplied recording data to EFM modulation, and outputs the data to the strategy circuit 18. The strategy circuit 18 subjects the EFM signal supplied from the encoder 17 to a time axis correction processing or the like, and outputs the signal to the laser driver 19. The laser driver 19 drives the laser diode of the optical pickup 10 in response to the signal modulated in accordance with the recording data supplied from the strategy circuit 18, and in response to the control of the laser power control circuit 20.

The laser power control circuit 20 controls a laser power emitted from the laser diode of the optical pickup 10. Concretely, the laser power control circuit 20 controls the laser driver 19 so as to irradiate from the optical pickup 10 the laser beam having a value which agrees with a target value of the optimum laser power determined by the controller 16. This laser power control is normally a feedback control in which the laser power control circuit 20 uses a current value supplied from the monitor diode of the optical pickup 10.

The controller 16 is constituted of a central processing unit (CPU) 16A, read only memory (ROM) 16B and random access memory (RAM) 16C, and is constituted to control components of the optical disk recording apparatus in accordance with a program stored in the ROM 16B which is one of machine-readable media, and to control the recording processing with respect to the optical disk D.

Similarly as a controller mounted on a general optical disk recording apparatus, the controller 16 executes control processing for recording data supplied from the host PC 110 into the optical disk D, and also performs the following characteristic processing. That is, the controller 16 can execute processing for controlling the laser beam emitted by the optical pickup 10 during the recording in a plurality of types of control methods. Moreover, the controller 16 is constituted to select any control method or procedure from the plurality of executable control procedures in response to the situation or condition concerning the recording to be performed, and to execute the control according to the control procedure.

More concretely, the controller 16 refers to a database for selection stored in the ROM 16B, selects any one of control procedures from a plurality of procedures of executable control processing prepared beforehand as described above, and performs the control processing of the laser beam according to the control procedure.

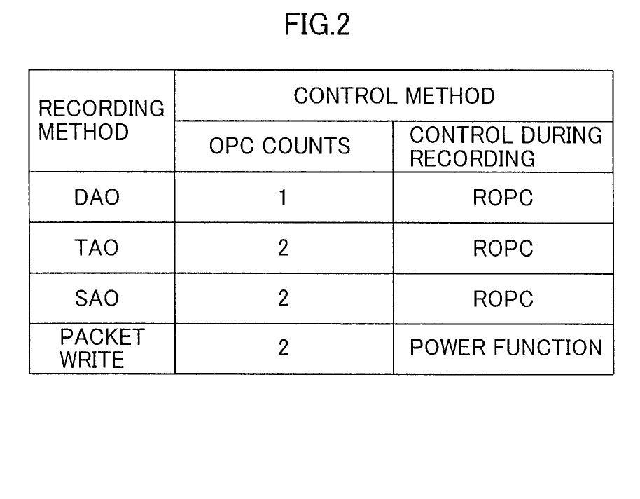

FIG. 2 shows a content of the database for use in selecting the control method. As shown in the drawing, in the database for selection, information indicating the control method of the laser power is associated with information indicating a plurality of types of recording methods. More concretely, the information indicating the different control methods of the laser power is associated with four recording methods “disc at once (DAO)”, “track at once (TAO)”, “session at once (SAO)”, and “packet write”.

Here, the “DAO” is a recording method of collectively generating data to be recorded in the optical disk D, and recording all data such as lead-in, recording substance data, and lead-out at once. The “TAO” is a recording method of recording the data a track by track unit, “SAO” is a recording method of recording data in a session by session basis, and these recording methods are also referred to as incremental write mode. If there is an unrecorded region in a disk capacity, the data can be recorded later in these recording methods. On the other hand, the abovedescribed “DAO” is a recording method in which the data cannot be recorded later regardless of the disk capacity. The “packet write” is a recording method in which the data is recorded by a packet unit, and is one of the recording methods referred to as the “incremental write” in which the data can be recorded later similarly as the “TAO” and “SAO”.

In the present embodiment, the following laser power control methods are associated with the above-described four types of recording methods in the database for selection. To perform the recording in any recording method, the laser power control method associated with the recording method is used. First, the recording method “DAO” is associated with the laser power control method of executing OPC once and using ROPC in adjusting the laser power during the recording, and this control procedure is used in performing the recording in the “DAO”. Moreover, the “TAO” and “SAO” are associated with the laser power control method of executing the OPC twice and using the ROPC in adjusting the laser power during the recording, and this laser power control procedure is used in performing the recording in these recording methods. Furthermore, the “packet write” is associated with the laser power control method of executing the OPC twice and using a power function in adjusting or regulating the laser power during the recording, and this laser power control procedure is used in performing the recording in the “packet write”.

The controller 16 refers to the database for selection in which the above-described information is stored, selects the laser power control method based on the recording method included in a recording instruction supplied from the host PC 110, controls the respective apparatus components and executes the laser power control according to the selected laser power control method. That is, the controller 16 accesses to the database for selection, and selects the laser power control method in accordance with the situation concerning the recording such as the recording method for recording the data by the instruction from the host PC 110.

The constitution of the optical disk recording apparatus 100 according to the present embodiment has been described above.

B. Operation of Embodiment

B-1. Outline of Processing

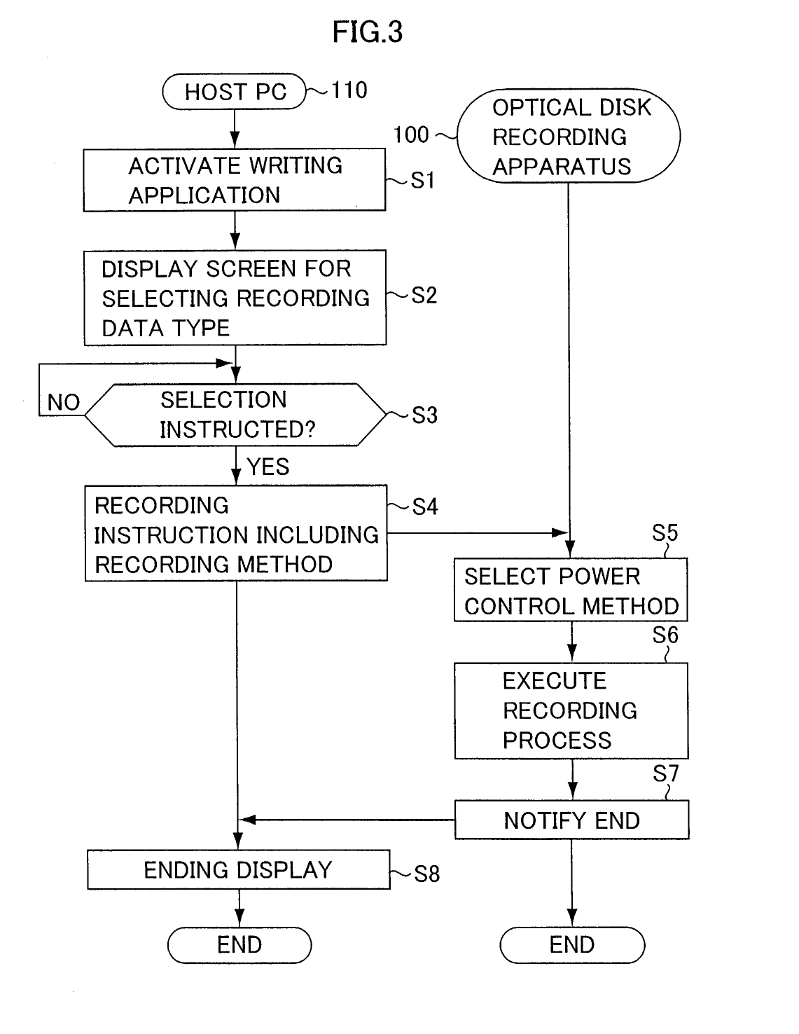

An operation of (the controller 16 of) the optical disk recording apparatus 100 and host PC 110 in performing the data recording by the optical disk recording apparatus 100 constituted as described above will next be described. First, an outline of processing by the host PC 110 and optical disk recording apparatus 100 during the recording will be described with reference to FIG. 3.

First, when a user instructs the host PC 110 connected to the optical disk recording apparatus 100 to start a writing application program in order to record the data in the optical disk D (such as CD-R), the CPU reads out the writing application program from a hard disk of the host PC 110, and the writing application is started (step S1).

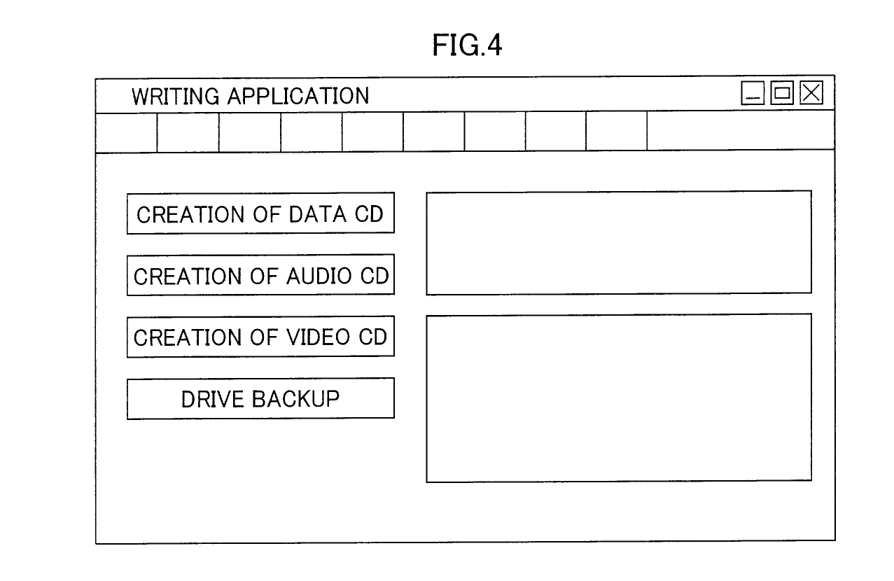

When the writing application is started, a screen prompting the selection of the type of data to be recorded is displayed in a display device (such as a liquid crystal display and cathode-ray tube (CRT)) of the host PC 110 by the application (step S2). Here, FIG. 4 shows one example of the screen which prompts the selection of the data type. As shown in the drawing, in this screen, in addition to columns for displaying a list of files or folders stored in the hard disk of the host PC 110, soft buttons for selecting the type of the data to be recorded are displayed such as “creation of data CD”, “creation of audio CD”, “creation of video CD” and “drive backup”. When the user appropriately operates a mouse or the like and clicks any one of the soft buttons, the user can select the type of the data to be recorded.

Here, the recording method corresponding to the selectable data type is allocated by default in the writing application, and the user selects/designates the data type, so that the recording method corresponding to the designated data type can be distinguished. In the writing application, the recording method “packet write” is allocated to the “creation of data CD”, the recording method “DAO” is allocated to the “creation of audio CD”, and the recording method “SAO” is allocated as the default to the “creation of data CD” and “backup of drive”. Additionally, these allocations can be changed by the user.

Upon displaying the screen shown in FIG. 4, the host PC 110 waits until there is a type selection and recording start instruction of the data by the user (step S3), and outputs recording instruction information including the recording method allocated to the selected data type to the controller 16 of the optical disk recording apparatus 100 in response to the instruction of the data type selection and recording start by the user (step S4). For example, when the user selects the “creation of data CD”, the recording instruction including the recording method “packet write” is outputted. When the “backup of drive” is selected, the recording instruction including the recording method “SAO” is outputted.

The controller 16 of the optical disk recording apparatus 100 having received the recording instruction including the recording method from the host PC 110 refers to the database for selection (see FIG. 2), and selects the laser power control method corresponding to the received recording method (step S5). When the recording method “SAO” is included as described above, the laser power control method of executing the OPC twice and adjusting the laser power with ROPC during the recording is selected.

The controller 16 selects the laser power control method based on the recording instruction including the recording method supplied from the host PC 110, performs the control processing according to the selected laser power control method, and performs the processing for recording the data supplied from the host PC 110 in the optical disk D (step S6).

Moreover, when the recording of the data ends, the controller 16 notifies the host PC 110 of the end of the recording (step S7), and the CPU of the host PC 110 having received this notice displays a message indicating the end of the recording in the display device (step S8).

The recording is executed using the laser power control method corresponding to the recording method specified by the data type designated by the user as described above.

B-2. Details of Laser Power Control

Details of the laser power control executed in accordance with the recording method specified by the data type designated by the user as described above will next be described in the optical disk recording apparatus 100 according to the present embodiment. As described above, in the optical disk recording apparatus 100, it is possible to record the data by four recording methods such as the “DAO”, “TAO”, “SAO” and “packet write”, and to execute the recording using three types of laser power control methods associated with the respective recording methods.

There will individually be described hereinafter: the first control method which is used with the recording method “DAO” and comprises executing the OPC once and using the ROPC in the laser power adjustment during the recording (hereinafter referred to as the control method a); the second control method which is used with the recording methods “TAO” and “SAO” and comprises executing the OPC twice and using the ROPC in the laser power adjustment during the recording (hereinafter referred to as the control method b); and the third control method which is used with the recording method “packet write” and comprises executing the OPC twice and using the power function in the laser power adjustment during the recording (hereinafter referred to as the control method c).

B-2-1. Control Method a

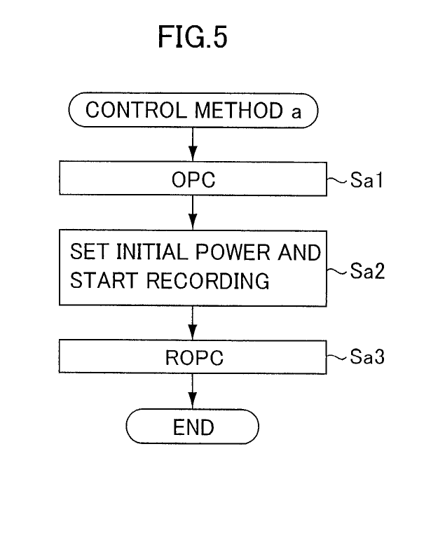

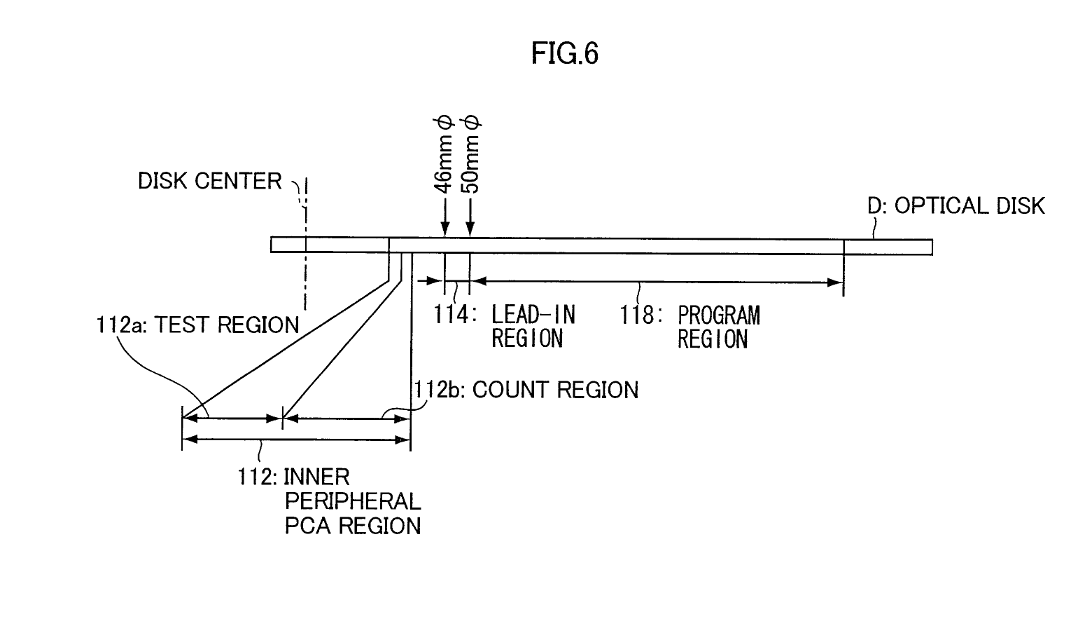

First, the control method a will be described with reference to FIG. 5. As shown in the drawing, in the laser power control of the controller 16 according to the control method a, first the respective apparatus components are controlled in order to perform the OPC (step SaA). As well known, the OPC is a processing which comprises: performing a test recording with respect to a power calibration area (PCA) (see FIG. 6) of the optical disk D (example of CD-R or CD-RW will be described); and obtaining an optimum laser power value based on the result of the test recording prior to a real recording. In the present embodiment, the recording is performed in the CAV method, and the controller 16 controls the servo circuit 13 so that the optical disk D is rotated at the same angular velocity as that of the real recording during the test recording in the OPC. In one test recording in the optical disk recording apparatus 100, the recording laser power value is changed in 15 stages, an EFM signal for one sub code frame per one recording laser power value is recorded, and the EFM signals for 15 frames in total are recorded.

Here, regions of the optical disk D (CD-R) under test record will be described with reference to FIG. 6. A section having a diameter of 46 to 50 mm in the optical disk D is prepared as a lead-in region 114, and a program region 118 for recording the content data and a residual region are prepared on an outer peripheral side. On the other hand, an inner peripheral power calibration area (PCA) region 112 is prepared on the inner peripheral side from the lead-in region 114. In the inner peripheral PCA region 112, a test region 112a and count region 112b are prepared, and the test recording is performed in the test region 112a prior to the above-described real recording processing. Here, a region in which the test recording can be performed many times is prepared as the test region 112a, and the EFM signal indicating the recorded portion of the test region 112a in which the test recording has been performed is recorded in the count region 112b at the end of each test recording. Therefore, to perform the next test recording with respect to the optical disk D, the EFM signal of the count region 112b is read, and a position of the test region 112a from which the next test recording is to be performed is thereby recognized. In the optical disk recording apparatus 100, the test recording is performed in the above-described test region 112a before performing the real recording.

The controller 16 rotates/drives the optical disk D at the same angular velocity as that of the above-described real recording, performs the test recording with respect to the optical disk D, and obtains the laser power value such that the β value detected from the reproduced signal of the test recording region by the β detection circuit 24 agrees with the predetermined target β value. That is, the controller 16 executes the OPC, and obtains the optimum laser power value by driving the optical disk D at the same angular velocity as that of the real recording and by recording the data in the PCA region on the inner peripheral side of the optical disk D.

The controller 16 rotates/drives the optical disk D at the same angular velocity as that of the real recording, performs the test recording with respect to the test region 112a as described above, obtains the optimum laser power value from the reproduced signal, and then starts the real recording. More concretely, the controller 16 controls the laser power control circuit 20 so that the optimum laser power value obtained by the OPC is set to an initial value of the power of the laser beam emitted to the optical disk D from the optical pickup 10, and starts the real recording (step Sa2).

When the above-described power value is used as the initial value to start the real recording, the controller 16 detects a level of reflected light from the optical disk D (a level of output signal of the RF amplifier 12), and controls the laser power output so that the level value of the output signal or the value uniquely specified by the level value becomes equal to a target value. That is, the laser beam emitted from the optical pickup 10 is controlled so that the laser power value of a time to start the real recording agrees the optimum laser power value obtained by the OPC, and thereafter the laser power is controlled by the ROPC (step Sa3).

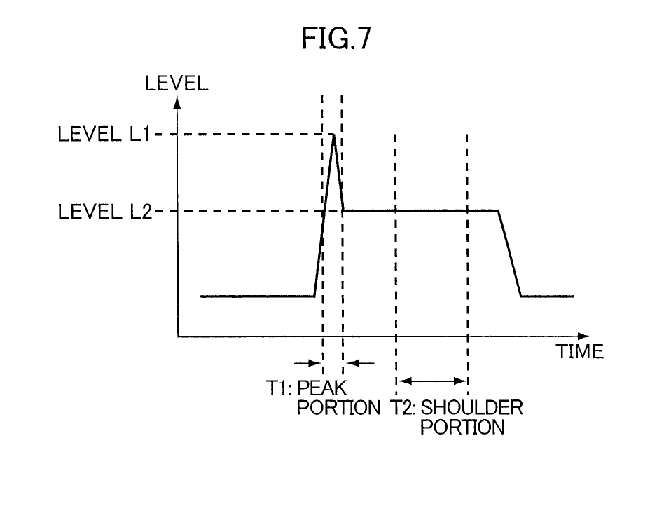

FIG. 7 exemplifies the output signal of the RF amplifier 12 in the recording. As shown in the drawing, the output signal of the RF amplifier 12 includes a peak portion T1 of a laser rising time and shoulder portion T2 in which the level becomes constant after the peak portion. When the shoulder portion has a constant level L2, the β value can also be judged to be constant. Alternatively, when a ratio value L1/L2 of a level L1 of the peak portion to the level L2 of the shoulder portion is constant, the β value can also be judged to be constant.

In the present embodiment, the controller 16 controls the laser power control circuit 20 so that the above-described level L2 of the shoulder portion (or the ratio L1/L2) indicates a predetermined value, and controls the power of the laser beam emitted from the optical pickup 10. Here, the controller 16 uses a relation between the laser power and the shoulder level which varies in accordance with the recording velocity obtained beforehand by experiments, and controls the laser power so as to obtain an optimum shoulder level in accordance with the recording velocity which varies because of the recording of the CAV method. More concretely, assuming that the laser power is P and the recording velocity is V, the laser power value P is controlled so that the following equation results in a fixed value obtained beforehand by the experiments.

L2^{a}×P^{b}×V^{c}×n (Equation 1)

In the above equation, a+b+c×n=0, and these a, b, c, n are constants obtained from the relation between the shoulder level and the laser power which varies in accordance with the recording velocity obtained beforehand by the experiments. Even in the laser power control by the conventional ROPC, the relation between the shoulder level and the laser power in a certain constant velocity is used. In the present embodiment, the relation between the shoulder level and the laser power is obtained by a plurality of velocities, and thereby the relation between the shoulder level and the laser power is obtained in consideration of the above-described velocity variation. For example, when a=2, b=−1, and n=1, a, b, c, n are obtained such that c=−1, and the value of the above Equation 1 has a degree of 0, that is, a constant.

The controller 16 controls the laser power control circuit 20 so that the optical pickup 10 emits the laser beam having the laser power obtained using the above Equation 1 obtained beforehand by the experiment. More concretely, the controller 16 applies the shoulder level L2 of each reflected light supplied from the RF amplifier 12 during the real recording and the recording velocity V obtained from the information concerning the recording position supplied from the ATIP detection circuit 14 and the rotation angular velocity of the optical disk D to the above Equation 1, then obtains the laser power value P so that the predetermined constant value results from the Equation 1, and controls the laser power control circuit 20 so that the laser beam having the obtained power value P is emitted.

The controller 16 controls the power of the laser beam emitted from the optical pickup 10 by the ROPC as described above until the real recording ends. The laser power control according to the control method a is used with the recording method DAO. Since the DAO is a recording method of performing the recording with respect to the unrecorded optical disk D only once, the recording start position of the DAO is a position on an innermost peripheral side of the program region 118 of the optical disk D (see FIG. 6). Moreover, the OPC is performed with respect to the test region 112a positioned on the inner peripheral side of the optical disk D in the control method a as described above, and it can be said that the test region 112a is in the position to start the recording in the DAO, that is, in substantially the same radial position as the position on the inner peripheral side of the program region 118. Therefore, also with the recording in the CAV method, since the recording positions (in a diametric direction of the disk) at the start of the real recording and during the test recording are extremely close to each other, the recording linear velocity is substantially the same. That is, in the start of the real recording, the optimum laser power value obtained from the result of the test recording at substantially the same recording linear velocity as the recording linear velocity of the recording start can be used, and the recording with a high quality level is performed in the recording start.

On the other hand, the optimum laser power value obtained by the OPC is effective as described above during the recording around the position on the inner peripheral side of the program region 118. However, when the recording position shifts toward the outer peripheral side, a difference between the linear velocity of the test recording and the linear velocity of the real recording increases. During the recording in the position other than the position on the inner peripheral side of the program region 118, it cannot necessarily be said that the optimum laser power value obtained by the OPC is optimum. Moreover, since the data capacity recorded in the DAO method is generally large in many cases (e.g., used in backing up another CD), the recording region is considered to reach the outer peripheral side of the program region 118 in many cases. Therefore, in the present embodiment, the optimum laser power value obtained by the OPC is used only in the position on the inner peripheral side of the program region 118 at the start of the recording. During the subsequent recording, the optical disk D can be irradiated with the laser beam having the power value which is satisfactory even during the recording in the position on the outer peripheral side (=at a high velocity), and which is optimal for the recording even in the recording position on the outer peripheral side of the optical disk D. As described above, the control method a is a laser control method preferable for the recording method of DAO in which the recording start position is the position on the innermost peripheral side of the program region 118, and the optical disk recording apparatus 100 is controlled according to the control method a with the recording method DAO.

B-2-2. Control Method b

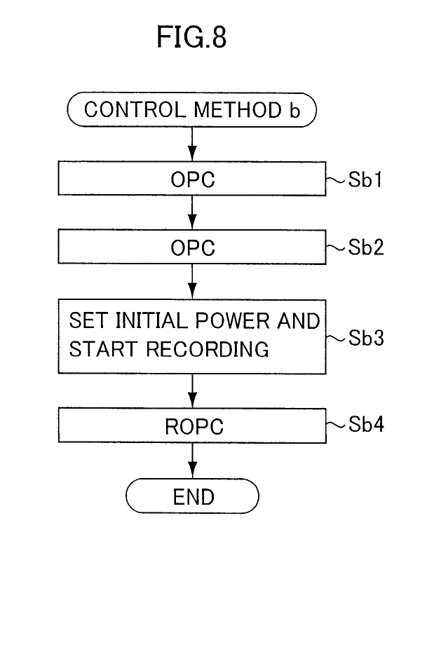

The control method b will next be described with reference to FIG. 8. As shown in the drawing, in the laser power control of the controller 16 according to the control method b, first the respective apparatus components are controlled in order to perform the first OPC (step Sb1). As described above in the OPC, the test recording is performed with respect to the test region 112a (see FIG. 6) of the optical disk D, and the optimum laser power value is obtained based on the result of the test recording. In the control according to the control method b, the controller 16 controls the servo circuit 13 during the test recording in the OPC so that the recording is performed at a linear velocity Vmax higher than that of the real recording. In the test recording by the optical disk recording apparatus 100, the recording laser power value is changed in 15 stages, the EFM signal for one sub code frame is recorded per one recording laser power value, and the EFM signals for 15 frames in total are recorded.

The controller 16 rotates/drives the optical disk D to perform the recording at the linear velocity Vmax higher than that of the above-described real recording, performs the test recording with respect to the optical disk D, and obtains the laser power value such that the β value detected from the test recording region by the β detection circuit 24 agrees with the predetermined target β value. That is, the controller 16 executes the OPC, and obtains the optimum laser power value while rotating/driving the optical disk D such that the recording is performed with respect to the PCA region on the inner peripheral side of the optical disk D at the linear velocity Vmax.

The controller 16 rotates/drives the optical disk D so that the recording is performed as described above with respect to the test region 112a at the linear velocity Vmax, performs the test recording and obtains the optimum laser power value from the reproduced signal. Then, the controller rotates/drives the optical disk D at the same angular velocity (this linear velocity is set to V) as that of the real recording start, performs the second test recording, and obtains the optimum laser power value from the result similarly as described above. That is, the controller 16 executes the second OPC (step Sb2), and obtains the optimum laser power value during the recording at the linear velocity V by the OPC.

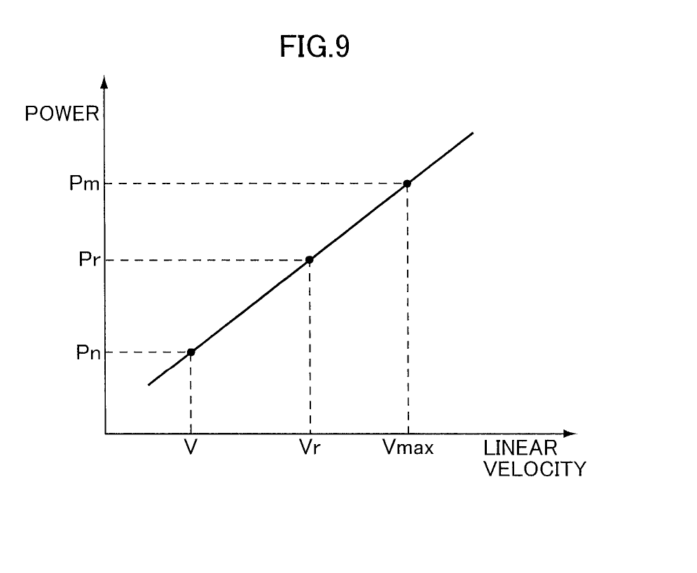

After the two OPCs are ended as described above, as shown in FIG. 9, the controller 16 obtains an initial power value Pr of the laser beam emitted from the optical pickup 10 during the real recording start from an optimum laser power value Pm obtained from the result of the first test recording in the linear velocity Vmax, another optimum laser power value Pn obtained from the result of the second test recording in a linear velocity V, and a position R to start the real recording in the optical disk D. The principle will be described. First, the optimum laser power values Pm, Pn between two linear velocities are interpolated (linear interpolation in the shown example), and thereby the relation between the recording linear velocity and optimum laser power is obtained (see FIG. 9). As described above, the recording positions are substantially the same in two OPCs, but the rotation angular velocities of the optical disk D differ in the first and second test recordings, and the recording linear velocities of the recordings differ. Here, the recording linear velocity of the first test recording in which the optimum laser power value Pm is obtained is Vmax, and the recording linear velocity of the second test recording in which the optimum laser power value Pn is obtained is V.

Upon obtaining the relation between the recording linear velocity and the power as shown in FIG. 9, the controller 16 obtains the recording linear velocity (=Vr) during the rotating/driving of the optical disk D at the predetermined angular velocity with respect to the position R to start the real recording in the optical disk D. Moreover, the controller obtains the optimum laser power value Pr corresponding to the recording linear velocity Vr from the relation between the recording linear velocity and the power. Practically, when the recording method is SAO or TAO, the recording is sometimes started from a midway position of the optical disk D, and these recording start positions can be acquired by reading a program memory area (PMA) in the optical disk D.

The controller 16 uses the power value Pr obtained by two OPCs as described above as the initial value to start the real recording (step Sb3). Moreover, after the recording is started in this manner, the controller 16 controls the laser power by the ROPC in consideration of the velocity variation similarly as the control method a (step Sb4).

Moreover, the controller 16 controls the power of the laser beam emitted from the optical pickup 10 by the ROPC as described above until the real recording ends. The laser power control according to the control method b is used, when the recording method is TAO or SAO. As described above in TAO or SAO, the recording sometimes starts from the midway position in the optical disk D. To start the recording from the position to some degree on the outer peripheral side, when the optimum laser power value in the position on the innermost peripheral side as in the control method a is used as the initial value, the satisfactory recording cannot be performed. Therefore, to record the data in the recording methods such as TAO and SAO, the control is performed according to the control method b, that is, two OPCs are performed, thereby the relation between the recording linear velocity and the optimum power is obtained, and the optimum power value corresponding to the recording start position is used as the laser power value during the recording start. Moreover, the recording is performed with the optimum laser power in the recording start in this manner. Furthermore, after the recording start, similarly as the control method a, the power is controlled using the ROPC with the linear velocity variation considered therein, so that the recording with the high quality level is performed in any recording position.

B-2-3. Control Method c

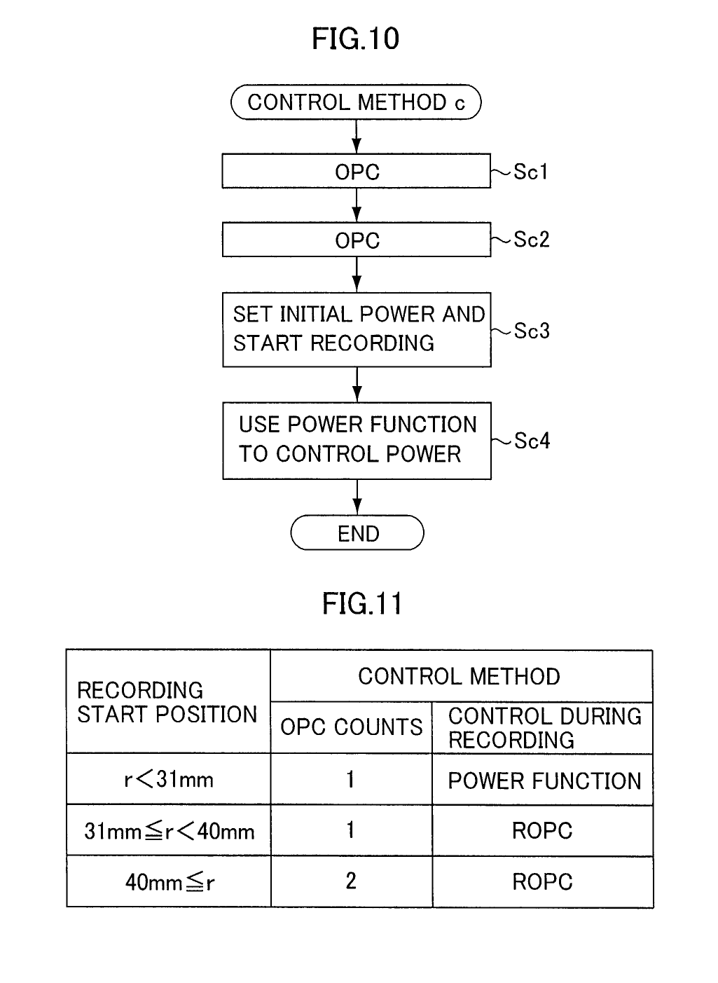

The control method c will next be described with reference to FIG. 10. As shown in the drawing, in the laser power control of the controller 16 according to the control method c, first the apparatus components are controlled in order to execute the OPC. As described above in the OPC, the test recording is performed with respect to the test region 112a (see FIG. 6) of the optical disk D, and the optimum laser power value is obtained based on the result of the test recording. In the control according to the control method c, similarly as the control method b, the controller 16 performs the test recording at two different velocities such as the linear velocities Vmax, V, and obtains the optimum laser power value Pr at the recording start position from the result of each test recording. Moreover, the controller 16 uses the power value Pr obtained by two OPCs as the initial value to start the real recording as described above (steps Sd1 to Sc3).

After starting the recording as described above, the controller 16 uses the relation between the recording linear velocity and the power obtained by two OPCs (see FIG. 9). More concretely, the controller 16 controls the laser power control circuit 20 so that the optical disk D is irradiated with the optimum laser power corresponding to the recording linear velocity varying with the recording position in accordance with the relation (power function) between the recording linear velocity and the power (step Sc4).

Subsequently, the controller 16 controls the power of the laser beam emitted from the optical pickup 10 in accordance with the relation between the recording linear velocity and the power as described above until the real recording ends. The laser power control according to the recording method c is used, when the recording method is the packet write. In the packet write, it is possible to record the data in the optical disk D, when the recording data unit is a very fine data unit such as a packet unit. When the data amount to be recorded is small, accuracy of the control using the above-described ROPC is sometimes impaired. Therefore, to perform the recording in the packet write method, the power is controlled according to the control method c, that is, two OPCs are performed to obtain the relation between the recording linear velocity and the optimum power, and the optimum power value corresponding to the recording start position is used as the laser power value during the recording start. Moreover, in the recording start, the recording is performed with the optimum laser power in this manner. Even after the recording start, the relation between the recording linear velocity and the power obtained by the OPC is used, and the satisfactory recording can be performed to some degree even during the recording of a small data amount.

As described above in the optical disk recording apparatus 100 according to the present embodiment, when one of the recording methods such as DAO, TAO, SAO and packet write is used, the laser power control preferable for the employed recording method is selected. Therefore, even with the recording using any recording method, the satisfactory recording can be performed with little generation of errors.

Moreover, in the present embodiment, the user refers to the displayed screen of the host PC 110 simply to select the type of the data to be recorded, then the recording method is automatically determined, and the recording is performed using the laser power control preferable for the determined recording method. Therefore, the user does not have to perform special operations such as the selection of the recording method and laser power control method, and may only perform the operation similar to that of the recording by the conventional optical disk recording apparatus.

Additionally, when the above-described control methods a, b and c are allocated to the above-described recording methods and employed, the above-described action/effect is obtained in a general drive apparatus, and the above-described allocation cannot sometimes be optimum depending on capabilities of the disk drive apparatus. Therefore, the recording method to which the control method is to be allocated is appropriately determined for each type of the disk drive apparatus by experiments.

C. Modification Example

Additionally, the present invention is not limited to the above-described embodiment, and various modifications exemplified hereinafter are possible.

### MODIFICATION EXAMPLE 1

In the above-described embodiment, the user selects the data type, and the recording methods such as DAO and TAO are automatically determined, but the recording methods such as DAO and TAO may be designated directly by the user.

### MODIFICATION EXAMPLE 2

Moreover, in the above-described embodiment, any one of the control methods a, b and c is selected in accordance with the recording methods such as DAO and TAO and the power is accordingly controlled, but the laser power control method may be selected depending on a condition other than the above-described recording methods, and the laser power control method may be selected in accordance with other various situations of conditions concerning the recording.

For example, an appropriate method may be selected from a plurality of laser power control methods prepared beforehand in accordance with the real recording start position in the optical disk D. In case that the control method is selected in accordance with the recording position, the database for selection shown in FIG. 11 is stored in the ROM 16B of the controller 16. As shown in the drawing, in the database for selection, the information indicating the respective different control methods of the laser power is associated with three ranges of the optical disk D.

In the database, the respective different control methods are associated with three ranges including an inner recording start position r at a radius which is less than 31 mm from the center of the optical disk D, a medium recording start position r at a radius which is not less than 31 mm and less than 40 mm, and an outer recording start position r at a radius of 40 mm or more.

Therefore, in the modification example, the controller 16 refers to the database for selection, selects the control method in matching with the recording start position and executes the power control. Here, the controller 16 reads the information recorded in the PMA region of the optical disk D, and detects the position r to start the real recording, before performing the real recording in the recording operation.

For example, when the detected recording start position r is less than 31 mm, the controller 16 selects the control method of executing the OPC once and using the power function in the laser power regulation during the recording and executes the power control accordingly. This is because that, with the recording start position r on the inner peripheral side, the recording is considered to be performed unlikely in the position of the outer peripheral side, the recording linear velocity variation is considered to be a little, the recording start position r also has a small difference from the position of the test region 112a and there is also supposedly a small difference between the linear velocity of the test recording and the linear velocity of the recording start. In this case, the preferable laser power of the recording start can sufficiently be obtained even with one OPC. Moreover, without using the ROPC effective for a case in which the linear velocity largely varies and the recording is performed on the outer peripheral side, a relatively simple power control is carried out using one OPC and a power function, and thus a time required for the recording is shortened.

Moreover, when the recording start position r is not less than 31 mm and less than 40 mm, the laser power control method of executing the OPC once and using the ROPC in the laser power adjustment during the recording, that is, the control method a is selected and the power control is executed accordingly. This is because that the recording start position r is in an area in the vicinity of the middle of the program region 118 of the optical disk D, and the recording is likely performed up to the position on the outer peripheral side of the optical disk D in many cases. In this case, the recording start position r is not largely apart from the test region 112a. Therefore, even when the laser power obtained by one OPC is used as the initial power, the recording quality level is not largely influenced, only one OPC is executed and the time required for the recording is shortened. On the other hand, it is considered that the recording span covers the position on the outer peripheral side of the optical disk D in many cases. Therefore, the ROPC effective for the recording in the position on the outer peripheral side is used in the power control at and after the recording start.

Furthermore, when the recording start position r is 40 mm or more, the laser power control method of executing the OPC twice and using the ROPC in the laser power adjustment during the recording, that is, the control method b is selected and the power control is executed accordingly. This is because that the recording start position r is a position on the outer peripheral side of the optical disk D, and this position is largely apart from the test region 112a. In this case, two OPCs are performed, the optimum laser power in the recording start position is more accurately obtained, and the ROPC preferable for the recording in the position on the outer peripheral side is used at and after the recording start.

The preferable power control procedure can be selected in accordance with the recording condition represented by the start position as described above so as to control the laser power. In general, the selecting section of the inventive optical disk recording apparatus selects the control procedure effective to enable the control section to regulate an irradiation power of the laser beam with a regulation accuracy matching a quality level of recording information indicated by the acquired recording condition.

Specifically, the selecting section operates when the acquired recording condition (r<31 mm) indicates or requires a first quality level of recording information for selecting an open-loop control procedure (using Power function) effective to provide the regulation accuracy of the irradiation power in matching with the first quality level, and operates when the acquired recording condition (40 mm>r) indicates or requires a second quality level higher than the first quality level for selecting a feedback-loop control procedure (ROPC) effective to secure the regulation accuracy higher than that provided by the open-loop control procedure. The feedback-loop control procedure enables the control section to regulate the irradiation power of the laser beam while monitoring a signal of the laser beam reflected back from the optical disk to feed back the monitored signal to the regulating of the irradiation power. In contrast, the open-loop control procedure allows the control section to regulate the irradiation power of the laser beam without monitoring a signal of the laser beam reflected back from the optical disk.

Further, the selecting section operates when the acquired recording condition (r<31 mm) indicates or requires the first quality level of recording information for selecting a velocity-independent control procedure effective to provide the regulation accuracy of the irradiation power matching the first quality level. The velocity-independent control procedure (control method a shown in FIG. 5) is effective to allow the control section to initially set an optimal value of the irradiation power independently of an initial linear velocity of the optical disk. Otherwise the selecting section operates when the acquired recording condition (40 mm<r) indicates or requires the second quality level higher than the first quality level for selecting a velocity-dependent control procedure effective to secure the regulation accuracy higher than that provided by the velocity-independent control procedure. The velocity-dependent control procedure (control method b shown in FIG. 8) is effective to enable the control section to initially set an optimal value of the irradiation power dependently of an initial linear velocity of the optical disk at start of the operation of recording information.

### MODIFICATION EXAMPLE 3

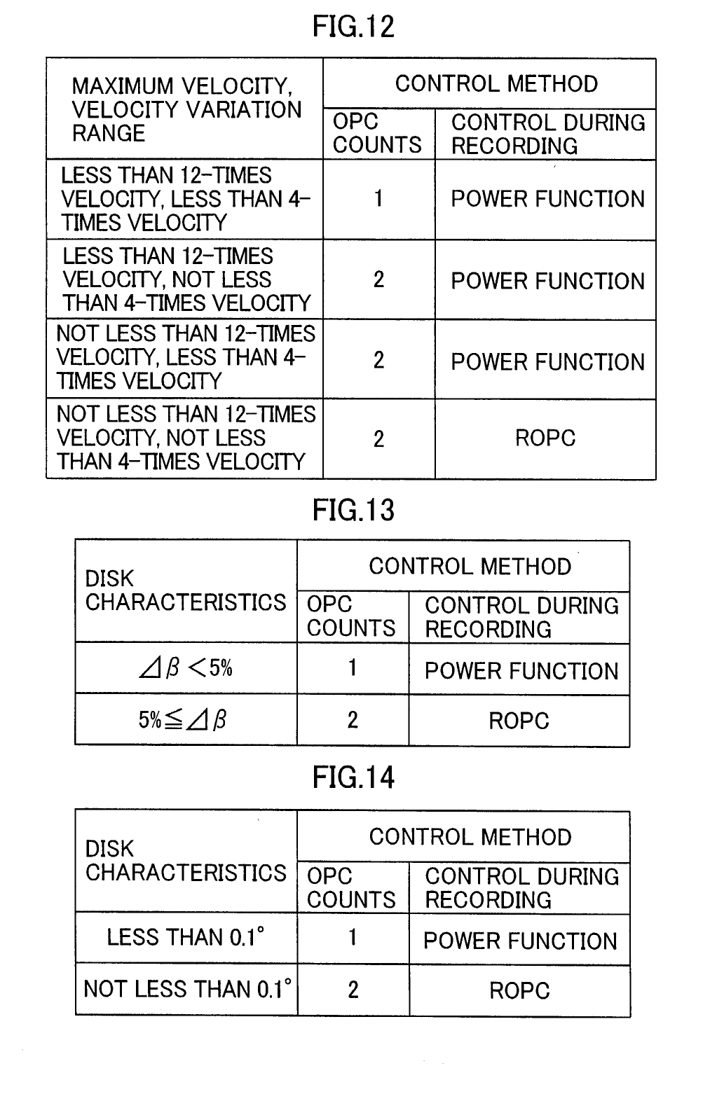

Moreover, the power control method may be selected in accordance with a maximum recording velocity during the real recording and/or a velocity change amount in the recording, in addition to the above-described recording method and recording start position. When the control method is selected in accordance with the maximum recording velocity, the database for selection shown in FIG. 12 is stored beforehand in the ROM 16B of the controller 16. As shown in the drawing, in the database for selection, the information indicating the respective different control methods of the laser power is associated with four ranges of the maximum recording velocity and velocity change amount and stored.

In the database, the different control methods are associated with four cases in which: the maximum velocity is less than 12-times velocity and the velocity change amount is less than 4-times velocity; the maximum velocity is less than 12-times velocity and the velocity change amount is not less than 4-times velocity; the maximum velocity is not less than 12-times velocity and the velocity change amount is less than 4-times velocity; and the maximum velocity is not less than 12-times velocity and the velocity change amount is not less than 4-times velocity. Additionally, the velocity change amount is a value obtained by Y-X in which the recording linear velocity in the recording start position is X-times velocity and the recording linear velocity in a recording end position is Y.

Therefore, in the modification example, the controller 16 refers to the database for selection, selects the control method in accordance with the maximum recording linear velocity and velocity change amount and executes the power control. Here, before performing the real recording in the recording operation, the controller 16 reads the information recorded in the PMA region of the optical disk D, detects the position to start the real recording, and obtains the recording end position (position on the outermost peripheral side) in the optical disk D in accordance with the detected recording start position and the data amount to be recorded supplied from the host PC 110. Moreover, the controller obtains the maximum recording linear velocity from the recording end position and the rotation angular velocity of the optical disk D in the recording. Furthermore, the controller 16 obtains the recording linear velocity in the recording start from the recording start position and the rotation angular velocity of the optical disk D, subtracts the recording linear velocity in the recording start from the maximum recording linear velocity, and obtains the velocity change amount.

When the database for selection shown in the drawing is stored, and when the obtained maximum recording linear velocity is less than 12-times velocity and the velocity change amount is less than 4-times velocity, the controller 16 selects the control method of executing the OPC once and using the power function in the laser power adjustment during the recording and executes the power control. With the maximum recording linear velocity and velocity change amount, it is considered that the recording is performed with respect to the position on the outer peripheral side in a few cases, and the recording start position is not much apart from the test region 112a. Moreover, the velocity change amount is also small. In this case, the sufficiently preferable laser power during the recording start can be obtained by only one OPC. Moreover, without using the ROPC effective for the large variation of the linear velocity or the recording on the outer peripheral side, the relatively simple power control is executed using one OPC and power function, and the time required for the recording is shortened.

Moreover, when the obtained maximum recording linear velocity is less than 12-times velocity and the velocity change amount is not less than 4-times velocity, the laser power control method of executing the OPC twice and using the power function in the laser power adjustment during the recording, that is, the control method c is selected and the power control is executed. In this case with the large velocity change amount, it is considered that more accurate power control needs to be executed, and therefore the control method c is employed.

Furthermore, when the obtained maximum recording linear velocity is not less than 12-times velocity and the velocity change amount is less than 4-times velocity, the laser power control method of executing the OPC twice and using the power function in the laser power adjustment during the recording, that is, the control method c is selected and the power control is executed. In this case with the high velocity, it is considered that more accurate power control needs to be executed, and therefore the control method c is employed.

Additionally, when the obtained maximum recording linear velocity is not less than 12-times velocity and the velocity change amount is not less than 4-times velocity, the laser power control method of executing the OPC twice and using the ROPC in the laser power adjustment during the recording, that is, the control method b is selected and the power control is executed. In this case with the high velocity and large velocity change amount, it is considered that most accurate power control needs to be executed, and therefore the control method c is employed.

### MODIFICATION EXAMPLE 4

Moreover, the power control method may also be selected in accordance with characteristics and type of the optical disk D to be recorded, in addition to the above-described recording method, recording start position and recording velocity. When the control method is selected in accordance with the characteristics and type of the optical disk D, the database for selection shown in FIG. 13 is stored in the ROM 16B of the controller 16. As shown in the drawing, in the database for selection, the information indicating the respective different control methods of the laser power is associated with two characteristics of the disk and stored.

In the database, the respective different power control methods are associated with two cases in which: a change ratio Δβ of the β value between the region of the optical disk D to be recorded on the innermost peripheral side and the region on the outermost peripheral side is less than 5% (in a range of 0 to less than 5%); and Δβ is 5% or more.

Therefore, in the modification example, the controller 16 refers to the database for selection, selects the control method in accordance with the characteristics of the optical disk D to be recorded and executes the power control. Here, before performing the real recording in the recording operation, the controller 16 reads disk identification information recorded in the lead-in region of the optical disk D, and detects the characteristics (change amount of β) of the optical disk D based on the read disk identification information. More concretely, a table with characteristics information stored therein is associated with disk type information of a large number of optical disks D available commercially and stored beforehand in the ROM 16B of the controller 16, the table is referred to and the characteristics of the optical disk D are detected.

For example, when the detected Δβ (change ratio of the β value) of the optical disk D is less than 5%, the controller 16 selects the control method of executing the OPC once and using the power function in the laser power adjustment during the recording and executes the power control. This is because the optical disk having a small β change amount is considered to be a disk having a relatively high quality level, and the sufficiently accurate recording is considered to be performed even with the relatively simple power control.

Moreover, when the detected Δβ (change ratio of the β value) of the optical disk D is 5% or more, the controller 16 selects the control method of executing the OPC twice and using the ROPC in the laser power adjustment during the recording, that is, the control method b and executes the power control. This is because the optical disk having a large β change amount is considered to be a disk having a relatively low quality level. If the power control is not executed precisely, the accurate recording is considered not to be performed.

Moreover, the characteristics of the disk are not limited to the above-described β change amount, and the power control method may be selected in accordance with the characteristics of the optical disk D such as a warp angle.

When the control method is selected in accordance with the warp angle of the optical disk D in this manner, the database for selection shown in FIG. 14 is stored beforehand in the ROM 16B of the controller 16. As shown in the drawing, in the database for selection, the information indicating the respective different control methods of the laser power is associated with two warp angle ranges of the disk and stored.

In the database, the respective different power control methods are associated with two cases in which: the warp angle of the optical disk D to be recorded is less than 0.1° (range of 0 to less than 0.1°); and the warp angle is 0.1° or more.

Therefore, in the modification example, the controller 16 refers to the database for selection, selects the control method in accordance with the warp angle of the optical disk D to be recorded and executes the power control. Here, before performing the real recording in the recording operation, the controller 16 reads the disk identification information recorded in the lead-in region of the optical disk D, and detects the warp angle of the optical disk D based on the read disk identification information. More concretely, the table with warp angle information stored therein is associated with the disk type information of a large number of optical disks D available commercially and stored beforehand in the ROM 16B of the controller 16, the table is referred to and the warp angle of the optical disk D is detected.

For example, when the detected warp angle of the optical disk D is less than 0.1°, the controller 16 selects the control method of executing the OPC once and using the power function in the laser power adjustment during the recording and executes the power control. This is because the optical disk having a small warp angle is considered to be a disk having a relatively high quality level, and the sufficiently accurate recording is considered to be performed even with the relatively simple power control.

Moreover, when the detected warp angle of the optical disk D is 0.1° or more, the controller 16 selects the control method of executing the OPC twice and using the ROPC in the laser power adjustment during the recording, that is, the control method b and executes the power control. This is because the optical disk having a large warp angle is considered to be a disk having a relatively low quality level. Unless the power control is executed precisely, the accurate recording is considered not to be performed.

### MODIFICATION EXAMPLE 5

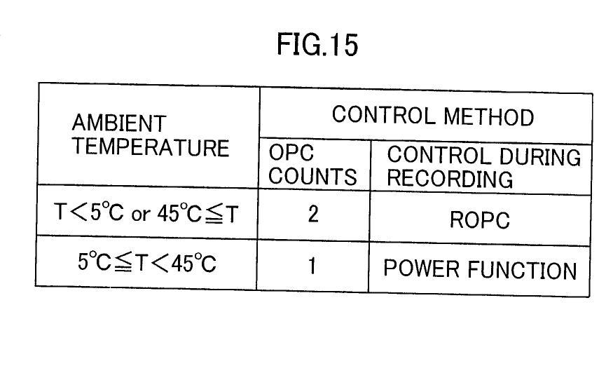

Moreover, the power control method may be selected in accordance with ambient environments (temperature and/or humidity) during the recording, in addition to the above-described recording method, recording start position, recording velocity and disk characteristics. When the control method is selected in accordance with the ambient environments during the recording, the database for selection shown in FIG. 15 is stored beforehand in the ROM 16B of the controller 16. As shown in the drawing, in the database for selection, the information indicating the respective different control methods of the laser power is associated with two ambient temperature ranges and stored.

In the database, the respective different power control methods are associated with two cases in which: temperature T in the vicinity of the optical pickup 10 during the recording is less than 5° C. or 45° C. or more; and the temperature T in the vicinity of the optical pickup 10 is 5° C. or more and less than 45° C.

Therefore, in the modification example, the controller 16 refers to the database for selection, selects the control method in accordance with the temperature in the vicinity of the optical pickup 10 during the recording and executes the power control. Here, a method of acquiring the temperature of the vicinity of the optical pickup 10 may comprise: disposing a special temperature sensor for selecting the power control method; or using detection results of a thermocouple sensor or infrared sensor for measuring the temperature of the laser diode disposed in the optical pickup of the optical disk recording apparatus so that the controller 16 acquires the temperature.

For example, when the detected temperature T is a low temperature such as less than 5° C., or a high temperature such as 45° C. or more, the controller 16 selects the control method of executing the OPC twice and using the ROPC in the laser power adjustment during the recording, that is, the control method b and executes the power control. This is because in the situation of the low or high temperature, the accuracy of the laser power control is lacking, then a recording error is generated with a high possibility, and the laser power control having a higher precision is required.

Moreover, when the detected temperature T is in a room temperature range of 5° C. or more and less than 45° C., the controller 16 selects the control method of executing the OPC once and using the power function in the laser power adjustment during the recording and executes the power control. This is because for the power control during the recording in the room temperature range, the precise power control is considered not to be required for the recording in a non-room temperature range. Since the simple method is used, the recording time is shortened.

### MODIFICATION EXAMPLE 6

Furthermore, the power control method may be selected in accordance with the region to be recorded in the optical disk D, in addition to the above-described recording method, recording start position, recording velocity, disk characteristics and environments. As described above in CD-R (see FIG. 6), the regions are prepared such as the program region 118 in which the data to be recorded is recorded, lead-in region 114 disposed on the inner peripheral side of the program region, and lead-out region (not shown in FIG. 6) disposed on the outer peripheral side of the program region 118. The power control method may be selected in accordance with the recording region to be recorded in these recording regions. For example, when only an operation of closing a session is performed instead of recording the data to be recorded with respect to the optical disk D, the data is not recorded in the program region 118, and is recorded only in the lead-in region 114 and lead-out region. In this case, as compared with the recording in the program region 118, the simple power control method is used. Here, a record amount with respect to the lead-in region 114 or the lead-out region is small as compared with the data amount recorded in the program region 118, and the same information is repeatedly recorded. Therefore, even when there is some error in the recording with respect to the lead-in region 114 or the lead-out region, a large problem is hardly generated. On the other hand, when there is a recording error in the program region 118, a problem that the recorded data cannot be reproduced occurs with a high possibility. Therefore, to record the data in the program region 118, the laser power control having a higher precision may be employed.

### MODIFICATION EXAMPLE 7

Moreover, in the optical disk recording apparatus 100 according to the above-described embodiment, the data is recorded by the CAV method, but other recording methods may be used. For example, there is a recording method (ZCLV: Zoned Constant Linear Velocity) comprising: dividing the disk into three regions of an inner periphery, mid periphery, and outer periphery; and allowing the disk rotation velocity to differ with each region, but the present invention can also be applied to the optical disk recording apparatus in which the recording is performed by such recording method.

Furthermore, the present invention can also be applied to the optical disk recording apparatus for executing CAV recording as a recording method having a constant rotation angular velocity of the optical disk until the velocity reaches a certain set recording linear velocity V, and for performing CLV recording in the recording linear velocity V when and after the recording position moves toward the outer peripheral side and the recording linear velocity reaches the set recording linear velocity V, that is, for performing so-called partial CAV recording.

### MODIFICATION EXAMPLE 8

Additionally, instead of selecting the power control method in accordance with the respective situations concerning the recording, such as the above-described recording method, recording start position, recording velocity, disk characteristics, environments and recording region, the laser power control method may be selected by combining and considering a plurality of the above-described situations concerning the recording.

For example, when the recording method is DAO, the CAV method has 16-times to 20-times velocity, the recording data amount is (60 minutes), the β change ratio inside and outside the disk is small, and the ambient temperature is 28° C., the control method of executing the OPC once and using the ROPC in the laser power adjustment during the recording is selected.

Moreover, in another example, to perform only the operation of closing the disk (bringing the disk to a state in which the data is not recorded any more), with the CAV method with 16-times to 20-times velocity, large β change ratio inside and outside the disk, and temperature of 46° C., the control method of executing the OPC once and using the power function in the power control during the recording is selected.

Furthermore, in still another example, in a case in which the recording method is TAO, the ZCLV method has 16-times to 24-times velocity, the β change ratio inside and outside the disk is medium, and temperature is 21° C., the power control method of executing the OPC twice and using the ROPC in the laser power adjustment during the recording is selected.

Here, a plurality of situations concerning the recording may optionally be considered in selecting the power control method. For example, this may comprise: preparing a table in which all combinations of a plurality of situations concerning the recording are associated with the power control method to be selected, and referring to the table; or determining priorities of the respective situations concerning the recording, and selecting the power control method particularly in consideration of the situation concerning the recording which has a high priority.

### MODIFICATION EXAMPLE 9

In the above-described embodiment, the CD-R or the CD-RW is assumed as the optical disk D, but the present invention may be applied to the optical disk recording apparatus which records the data in other optical disks such as a digital versatile disc (DVD)-RW disk, and DVD-RAM disk.

### MODIFICATION EXAMPLE 10

Moreover, in the above-described embodiment and various modification examples, the laser power control method is selected in accordance with the situation concerning the recording, but the method is not limited to the laser power control method as long as the laser beam emitted from the optical pickup 10 is controlled in the method. For example, an optimum write strategy control method may be selected from a plurality of write strategy control methods which are prepared beforehand and which can be executed by the optical disk recording apparatus 100 in accordance with the above-described various situations concerning the recording.

### MODIFICATION EXAMPLE 11

Furthermore, in the above-described embodiment, the controller 16 executes a program group stored beforehand in the ROM 16B of the controller 16 and uses a data group stored in the ROM 16B to select the above-described recording laser power control method and to execute the laser power control by the selected method. However, various recording mediums such as CD-ROM in which program for allowing a computer to realize the processing is recorded may be supplied to the user, or the program may be supplied to the user via transmission mediums such as Internet.

As described above, according to the present invention, even when a situation or condition concerning a recording changes, the recording is performed with a good balance between a recording quality level and a required time, and a preferable recording can be performed in accordance with the various situation in this manner.

What is claimed is:

1. An optical disk recording apparatus for recording information on an optical disk by irradiation of a laser beam according to a given control procedure under a given recording condition, the apparatus comprising:
an acquiring section that acts when an operation of recording information is performed for acquiring the recording condition associated to the operation to be performed;
a selecting section that selects a control procedure according to the acquired recording condition from a plurality of different control procedures which are prepared beforehand; and
a control section that controls the irradiation of the laser beam according to the selected control procedure during the operation of recording information.

2. The optical disk recording apparatus according to claim 1, wherein the acquiring section acts to acquire the recording condition in response to an instruction of a user who initiates the operation of recording information.

3. The optical disk recording apparatus according to claim 2, wherein the acquiring section acquires the recording condition representative of a kind of information which is specified by the user to be recorded in the optical disk.

4. The optical disk recording apparatus according to claim 1, wherein the acquiring section acquires the recording condition indicative of whether the operation of recording information to be performed is of an incremental write mode allowing additional recording of information at a next operation or a write-at-once mode not allowing additional recording.

5. The optical disk recording apparatus according to claim 1, wherein the acquiring section acquires the recording condition indicative of a start position of the optical disk from which the information is recorded in the optical disk.

6. The optical disk recording apparatus according to claim 1, wherein the acquiring section acquires the recording condition representative of a maximum velocity of recording information, which is set in the operation to be performed.

7. The optical disk recording apparatus according to claim 1, wherein the acquiring section acquires the recording condition representative of a range of variation in a linear velocity of recording information.

8. The optical disk recording apparatus according to claim 1, wherein the acquiring section acquires the recording condition representative of a recording characteristic of the optical disk which is used to record information.

9. The optical disk recording apparatus according to claim 1, wherein the acquiring section acquires the recording condition representative of an environmental factor including at least one of a temperature and a humidity around the optical disk which is used in the operation of recording information.

10. The optical disk recording apparatus according to claim 1, wherein the acquiring section acquires the recording condition indicative of whether a target region of the optical disk to be recorded with information includes only one or both of a lead-in region and a lead-out region, or includes other region in addition to one or both of a lead-in region and a lead-out region of the optical disk.

11. The optical disk recording apparatus according to claim 1, wherein the selecting section selects the control procedure effective to enable the control section to regulate an irradiation power of the laser beam with a regulation accuracy matching a quality level of recording information indicated by the acquired recording condition.

12. The optical disk recording apparatus according to claim 11, wherein the selecting section operates when the acquired recording condition indicates a first quality level of recording information for selecting an open-loop control procedure effective to provide the regulation accuracy of the irradiation power in matching with the first quality level, and operates when the acquired recording condition indicates a second quality level higher than the first quality level for selecting a feedback-loop control procedure effective to secure the regulation accuracy higher than that provided by the open-loop control procedure.

13. The optical disk recording apparatus according to claim 12, wherein the selecting section selects the open-loop control procedure effective to allow the control section to regulate the irradiation power of the laser beam without monitoring a signal of the laser beam reflected back from the optical disk, and otherwise the selecting section selects the feedback-loop control procedure effective to enable the control section to regulate the irradiation power of the laser beam while monitoring a signal of the laser beam reflected back from the optical disk to feed back the monitored signal to the regulating of the irradiation power.

14. The optical disk recording apparatus according to 11, wherein the selecting section operates when the acquired recording condition indicates a first quality level of recording information for selecting a velocity-independent control procedure effective to provide the regulation accuracy of the irradiation power matching the first quality level, the velocity-independent control procedure being effective to allow the control section to initially set an optimal value of the irradiation power independently of an initial linear velocity of the optical disk, and otherwise the selecting section operates when the acquired recording condition indicates a second quality level higher than the first quality level for selecting a velocity-dependent control procedure effective to secure the regulation accuracy higher than that provided by the velocity-independent control procedure, the velocity-dependent control procedure being effective to enable the control section to initially set an optimal value of the irradiation power dependently of an initial linear velocity of the optical disk at start of the operation of recording information.

15. A method of recording information on an optical disk by irradiation of a laser beam according to a given control procedure under a given recording condition, the method comprising the steps of:
acquiring the recording condition when an operation of recording information is performed, the recording condition being associated to the operation to be performed;
selecting a control procedure according to the acquired recording condition from a plurality of different control procedures which are prepared beforehand; and
controlling the irradiation of the laser beam according to the selected control procedure during the operation of recording information.

16. A machine readable medium for use in an optical disk recording apparatus having a processor and recording information on an optical disk by irradiation of a laser beam according to a given control procedure under a given recording condition, the medium containing program instructions executable by the processor for causing the optical disk recording apparatus to carry out a process comprising the steps of:
acquiring the recording condition when an operation of recording information is performed, the recording condition being associated to the operation to be performed;
selecting a control procedure according to the acquired recording condition from a plurality of different control procedures which are prepared beforehand; and
controlling the irradiation of the laser beam according to the selected control procedure during the operation of recording information.
